(19) United States
(12) Patent Application Publication
(10) Pub. No.: US 2010/0318672 A1
(43) Pub. Date: Dec. 16, 2010

(54) Method and Apparatus for Compatible Media Enclosures in Syndicated Feeds

(75) Inventor: Imed Bouazizi, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/815,804

(22) Filed: Jun. 15, 2010

Related U.S. Application Data
(60) Provisional application No. 61/187,026, filed on Jun. 15, 2009.

(51) Int. Cl. G06F 15/16

(52) U.S. Cl. 709/231

(57) ABSTRACT

An apparatus for providing compatibility of media enclosures in feeds may include at least one processor and at least one memory including computer program code. The at least one memory and the computer program code may be configured, with the processor, to cause the apparatus to perform at least identifying content to be provided to a mobile terminal via a feed in which the content includes a media enclosure, and providing an indication of an alternative enclosure to the mobile terminal based on the media rendering capabilities of the mobile terminal. The indication of the alternative enclosure may include a namespace defining an extension including an address of the media enclosure, media information describing a media configuration of the alternative enclosure and a link reference describing access to the alternative enclosure. A corresponding method and computer program product are also provided.

### CROSS REFERENCE TO RELATED APPLICATION

This application claims the benefit of U.S. Provisional Application No. 61/187,026, filed Jun. 15, 2009, the contents of which are incorporated herein in their entirety.

### TECHNOLOGICAL FIELD

Embodiments of the present invention relate generally to information service technology and, more particularly, relate to a method, apparatus and computer program product for providing compatibility of media enclosures in feeds.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to the provision of services to users of electronic devices. Given the popularity of the Internet, and the vast sources of information that are accessible using the Internet, various Internet services have evolved to provide users with information from a plurality of different sources. Web feeds are an example of a data format that is becoming commonly used as a source for providing users of mobile and fixed electronic devices with access to a variety of information sources. Feeds are typically established by content distributors that syndicate a particular web feed in order to allow users to access the corresponding content associated with the feed by subscribing to the feed.

With recent developments in the area of content distribution, web feeds are becoming richer and richer in terms of the content that can be provided thereby. As an example, it is now possible to provide links to multimedia content as enclosures to web feeds. However, with the increased capability of devices to provide content via this mechanism, an increased frequency of encountering compatibility problems has also arisen. Accordingly, it may be desirable to provide a mechanism by which to provide rich content via a feed, while reducing the likelihood of encountering a compatibility problem.

### BRIEF SUMMARY OF SOME EXAMPLES OF THE INVENTION

A method, apparatus and computer program product are therefore provided to enable the provision of compatible media enclosures for feeds such as syndicated feeds. As such, for example, a feed may be established that may include enclosures, but may also include information to enable a device subscribing to the feed to reliably consume content via the feed with a reduced likelihood of encountering a compatibility problem. Accordingly, user experience may be enhanced.

In an example embodiment, a method of providing compatibility of media enclosures in feeds is provided. The method may include identifying content to be provided to a mobile terminal via a feed in which the content includes a media enclosure, and providing an indication of an alternative enclosure to the mobile terminal based on the media rendering capabilities of the mobile terminal. The indication of the alternative enclosure may include a namespace defining an extension including an address of the media enclosure, media information describing a media configuration of the alternative enclosure and a link reference describing access to the alternative enclosure.

In another example embodiment, an apparatus for providing compatibility of media enclosures in feeds is provided. The apparatus may include at least one processor and at least one memory including computer program code. The at least one memory and the computer program code may be configured, with the processor, to cause the apparatus to perform at least identifying content to be provided to a mobile terminal via a feed in which the content includes a media enclosure, and providing an indication of an alternative enclosure to the mobile terminal based on the media rendering capabilities of the mobile terminal. The indication of the alternative enclosure may include a namespace defining an extension including an address of the media enclosure, media information describing a media configuration of the alternative enclosure and a link reference describing access to the alternative enclosure.

In an example embodiment, a computer program product for providing compatibility of media enclosures in feeds is provided. The computer program product may include at least one computer-readable storage medium having computer-executable program code portions stored therein. The computer-executable program code portions may include program code portions for identifying content to be provided to a mobile terminal via a feed in which the content includes a media enclosure, and providing an indication of an alternative enclosure to the mobile terminal based on the media rendering capabilities of the mobile terminal. The indication of the alternative enclosure may include a namespace defining an extension including an address of the media enclosure, media information describing a media configuration of the alternative enclosure and a link reference describing access to the alternative enclosure.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates one example of an alternative communication system according to an exemplary embodiment of the present invention;

FIG. 3 illustrates a schematic block diagram of an apparatus for providing compatibility of media enclosures in web feeds according to an exemplary embodiment of the present invention; and

FIG. 4 is a flowchart according to an exemplary method for providing compatibility of media enclosures in web feeds according to an exemplary embodiment of the present invention.

### DETAILED DESCRIPTION OF SOME EMBODIMENTS OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Some embodiments of the present invention may provide a mechanism by which improvements may be experienced in relation to providing compatibility with respect to enclosures in feeds. In this regard, for example, some embodiments may provide for a mechanism for providing an extension to existing feed formats in a backward compatible manner. Accordingly, feed authors or aggregators may be enabled to provide alternative media enclosures to users to increase the likelihood of compatibility of the enclosures with the device attempting to open such enclosures.

Some embodiments may be particularly useful in connection with mobile devices. In this regard, for example, it has become possible to provide services such as podcasts, vodcasts, and others, via enclosure in a link of a feed. However, feeds often do not provide an adequate description of the linked enclosures to enable feed readers to, automatically or on user request, download referenced media. Thus, in some cases users may waste resources attempting to play media that their devices cannot play. For many desktop or personal computer (PC) environments, users may be capable of downloading and installing missing codecs in some situations. However, mobile users typically rely on a hardware-accelerated tailored implementation of a set of standardized media codecs and therefore lack the ability to easily install missing codecs. Thus, mobile users tend to be even more likely to encounter compatibility issues without implementing an embodiment of the present invention.

In order to provide a background for understanding some exemplary feed mechanisms that may be used in connection with some embodiments, a few select examples of feed mechanisms will be described. In this regard, some example feed mechanisms include really simple syndication (RSS), Atom, and dynamic content deliver (DCD). In general terms, a feed or web feed is a data format used for providing users with frequently updated content. Content distributors syndicate a web feed to allow users to subscribe to the feed.

In some cases, feeds are collected (or aggregated) and provided to users from a single location (via aggregation). In some cases, a web feed is also referred to as a syndicated feed. A feed typically delivers XML (extensible markup language) or HTML (hypertext markup language) formatted content. In some cases, a feed may include a link to one or more other web pages or media content sources. For example, news websites and blogs are very common sources for web feeds. However, other structured information such as weather data, hit music, top ten lists, and other types of content are also commonly associated with web feeds. In some situations, a summary about any new content associated with the feed and a link for enabling retrieval of the content is provided to subscribers. By providing notifications regarding new content and a link or other mechanism by which to enable access to such content, if desired, the size of the feeds may be substantially reduced and scalable usage of web feeds with a large number of users may be enabled. These characteristics have led to relatively widespread deployment of web feeds by different types of content providers.

Web feeds are thought of as being advantageous under certain circumstances. In this regard, for example, a web feed may be deemed advantageous when a content provider publishes a feed link on a web site to which end users can register with an aggregator (e.g., a program or entity configured to run a feed such as a feed reader or a news reader) that may be running locally or remotely. The aggregator may be configured to query, either periodically or upon user request, all the servers or other sources on a feed list defining locations at which various feeds may be accessed for new content availability. When new content is available, the aggregator may be configured to download parts of or all the content immediately and/or the aggregator may signal the availability of new content to the user. Thereafter, either automatically or in response to a user request, the aggregator or feed reader may be configured to download attached enclosures.

Accordingly, web feeds provide a relatively easy to employ mechanism to replace email newsletter types of services. Moreover, a web feed generally preserves user privacy and gives more control to the user over the subscribed feeds. As such, some advantages of feeds as compared to receiving frequently published content via email may include enhanced user privacy and protection, enhanced control and improved categorization. As to privacy, when subscribing to a feed, users do not disclose their email address. Accordingly, users are less exposed to the risk associated with email-related threats such as spam, viruses, phishing, and identity theft. As to control, a user may simply remove the feed from the user's aggregator in order to unsubscribe. This process for unsubscribing is typically simpler than the procedure required to unsubscribe from a newsletter. As to categorization, new entries are arranged under their respective feeds, which may enable users to gain immediate access to the latest entries of a specific feed. Such categorization may rely upon setting up appropriate rules for sorting of the incoming email newsletters to achieve the same sorting that can otherwise be provided by feed categorization.

A feed reader is often utilized for consuming and reading web feeds. After subscribing to a particular web feed, the user receives updated content that can be viewed by the feed reader. A wide variety of feed readers are available for use by users and many of the available feed readers are free. In some cases, an offline web feed reader is downloaded and installed to the user's device. However, online feed readers are also available that are hosted remotely and are accessible via the web. Feed readers may be configured and installed on personalized home page services that allow users to select from a variety of typical feeds such as news, weather, or stock quotes among other things. Third party feeds may also be added to the user's personalized page. Presently, there are a number of available online and mobile feed readers that are widely deployed. Moreover, many more recent email clients and web browsers have been enabled with feed reader functionality.

Syndication is a term that is typically used for denoting the publishing of a feed associated with a specific information source. The feed content may be shared and republished by other websites. As described above, feeds are typically subscribed to directly by users with aggregators or feed readers, which combine the content from multiple web feeds for display on a single screen or series of screens. Some modern web browsers incorporate aggregator features. Depending on the aggregator, users typically subscribe to a feed by manually entering the address (e.g., uniform resource locator (URL)) of a feed or clicking a link in a web browser.

Really Simple Syndication (RSS) is a family of web feed formats used to publish feeds in a standardized format. An RSS document (usually named feed, web feed, or channel) includes a descriptive summary text, and metadata about the feed such as publishing date, author, category, and expected validity. The standardized XML file format of RSS allows portability and feed reader independence. The user subscribes to a feed by entering the feed's URL into a feed reader or by clicking a link to the RSS feed on a browser that is able to associate the link with the RSS feed reader and to perform the subscription process.

There are several different versions of RSS, falling into two major branches including RSS RDF and RSS 2.*. The RDF (or RSS 1.*) branch of RSS includes several versions including RSS 0.90, RSS 1.0 and RSS 1.1. The RSS 2.* branch also includes several different versions including RSS 0.91, RSS 0.92, RSS 0.93, RSS 0.94 RSS 2.0 and RSS 2.0.1. For the most part, later versions in each branch are backward-compatible with earlier versions (aside from non-conformant RDF syntax in 0.90), and both versions include properly documented extension mechanisms using XML Namespaces, either directly (in the 2.* branch) or through RDF (in the 1.* branch). The extension mechanisms make it possible for each branch to track innovations in other branches. For example, the RSS 2.* branch was the first to support enclosures, making it the current leading choice for podcasting.

Table 1 below shows an an example of an RSS 2.0 file.

TABLE 1
<?xml version=”1.0”?>
<rss version=”2.0”>

<channel>

<title>Some News</title>
<link>http://thefeed.example.com</link>
<description>Some news feed.</description>
<language>en-us</language>
<pubDate>Mon, 8 Jun 2009 10:00:00 GMT</pubDate>
<lastBuildDate>Mon, 8 Jun 2009 09:40:00
GMT</lastBuildDate>
<docs>http://blogs.law.harvard.edu/tech/rss</docs>
<generator>Example Authoring Tool</generator>
<managingEditor>author@example.com</managingEditor>
<webMaster>webmaster@example.com</webMaster>
<ttl>5</ttl>
<item>

<title>Latest News</title>
<link>http://feed.example.com/news/latest.php</link>
<description>The latest news from today.</description>
<pubDate>Mon, 8 Jun 2009 09:30:00 GMT</pubDate>
<guid>http://feed.example.com/latest.php</guid>
<enclosure url=”http://feed.example.com/latest/item.mp4”

type=”video/mp4” length=”98723487”/>

</item>

</channel>
</rss>

Atom corresponds to a set of related standards including the Atom Syndication Format, which defines an XML schema that is used for web feeds, and the Atom Publishing Protocol (AtomPub or APP), which is an HTTP-based protocol for creating and updating web resources. As discussed above, web feeds allow software programs to check for updates published on a web site. To provide a web feed, the feed provider may make use of feed authoring and/or publishing tools. The feed may then be accessed using Atom enabled feed readers.

An Atom feed may include entries such as, for example, headlines, full-text articles, excerpts, summaries, links to content on a web site, and/or the like, along with various metadata. The Atom format typically provides a mechanism by which to explicitly and unambiguously label the type of content being provided by the entry, and also allows for a broad variety of payload types including plain text, escaped HTML, XHTML, XML, Base64-encoded binary, and references to external content such as documents, video, audio streams, and so forth. Atom typically uses a standard attribute to make it possible to specify a language context for every piece of human readable content in the feed. Atom also differs from RSS in that it supports the use of Internationalized Resource Identifiers, which allow links to resources and unique identifiers to contain characters outside a typical limited character set. The elements of the RSS vocabulary are not generally reusable in other XML vocabularies. The Atom syntax was specifically designed to allow elements to be reused outside the context of an Atom feed document. For instance, it is not uncommon to find elements being used within RSS 2.0 feeds.

DCD (Dynamic Content Delivery) corresponds to a set of standards specified by OMA BCAST (Open Mobile Alliance mobile broadcast services enabler suite). The DCD enabler ensures the delivery of dynamic content from the content provider to DCD clients. Similar to feeds, DCD defines DCD channels that are used to collect content entries or content items. DCD defines a state machine for the DCD channel, according to which each DCD channel will have a certain state at any point of time. The channel states include, for example, an inactive, active, and suspended state.

DCD clients register with the DCD server and perform during this step any necessary authorization and authentication procedures. DCD content providers also register with the DCD server in order to create a channel and to be able to publish DCD content. Content delivery takes place between the DCD server and the DCD client using bi-directional or unidirectional network access and in push or pull mode.

DCD uses XML syntax for describing the different metadata. DCD defines a DCD content metadata format and extensions to RSS and Atom. The DCD content packaging adds the DCD content metadata to the original content item (e.g. RSS or Atom) to create a DCD content envelope. Thus, for example, DCD may provide a mechanism by which to enclose the original content item within an envelope that may be provided via a feed.

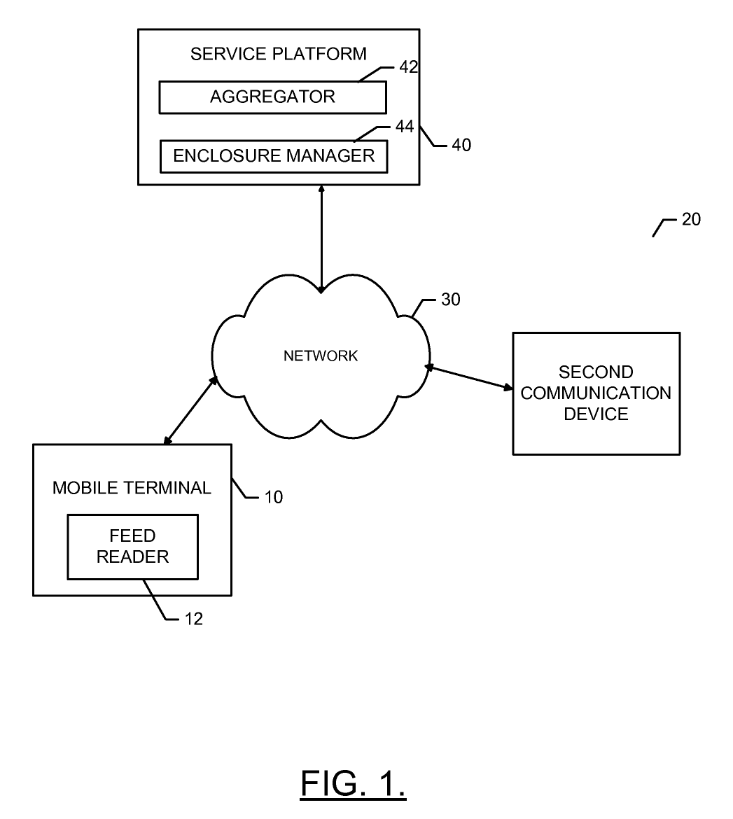

The above described formats are merely examples of different feed mechanisms or extensions to feed mechanisms and should not be seen as limiting to embodiments of the present invention. Instead, the above described formats are provided as a basis for knowledge regarding typical technologies that may be employed for providing web feeds. With the above provided backdrop, an exemplary embodiment of the invention will now be described in connection with the example communication system displayed in FIG. 1.

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more network devices such as a service platform 40 with which the mobile terminal 10 (and possibly also the second communication device 20) may communicate to provide, request and/or receive information.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and the second communication device 20 via the network 30. By directly or indirectly connecting the mobile terminal 10 and the second communication device 20 and other devices to the network 30, the mobile terminal 10 and the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, either of the first communication device and the second communication device 20 may be mobile or fixed communication devices. Thus, for example, the mobile terminal 10 and the second communication device 20 could be, or be substituted by, any of personal computers (PCs), personal digital assistants (PDAs), wireless telephones, desktop computer, laptop computers, mobile computers, cameras, video recorders, audio/video players, positioning devices, game devices, television devices, radio devices, or various other like devices or combinations thereof.

In an example embodiment, the service platform 40 may be a device or node such as a server or other processing element. The service platform 40 may have any number of functions or associations with various services. As such, for example, the service platform 40 may be a platform such as a dedicated server (or server bank) associated with a particular information source or service (e.g., an Internet service such as a news organization, a blog, or numerous other content or feed sources), or the service platform 40 may be a backend server associated with one or more other functions or services. As such, the service platform 40 may represent a plurality of different services or information sources. The functionality of the service platform 40 may be provided by hardware and/or software components configured to operate in accordance with known techniques for the provision of information to users of communication devices.

In an exemplary embodiment, one or more of the service platform 40 and the second communication device 20 may represent sources for information that may be consumed at the mobile terminal 10 in accordance with embodiments of the present invention. As such, for example, the service platform 40, the second communication device 20 and/or other devices may provide external information sources (e.g., information streams) that are accessible by the mobile terminal 10. In the context of embodiments of the present invention, external information streams may include feed streams of news, videos, blog entries, etc., email headers, social network site updates, and/or the like that may be provided by RSS, Atom, DCD or any other feed mechanism.

In the context of FIG. 1, according to one example, the service platform 40 may include an aggregator 42. The aggregator 42 may be any means such as a device or circuitry embodied in hardware, software or a combination of hardware and software that is configured to access content from various content sources based on user instructions (e.g., associated with subscriptions the user has generated) and aggregate the content for easy access by the user. In an exemplary embodiment, the aggregator 42 may be embodied as a web based application configured to, routinely or at predetermined intervals, check various web sites or other content sources based on user subscriptions. However, it should be noted that in some embodiments, the aggregator 42 may instead be embodied as a client device such that, for example, the aggregator 42 may be embodied at the mobile terminal 10.

In some cases, the aggregator 42 may be further configured to sort, filter, analyze or otherwise process content based on context and content using various algorithms that may operate automatically or based on predefined criteria. In an exemplary embodiment, after the aggregator 42 collects information regarding content that the user (or potential users) may find of interest based on user preferences or the purpose of the aggregator 42 (e.g., new content), the aggregator 42 may be configured to either feed the new content associated with the checked web sites or content sources to the user or provide the user with an indication regarding availability of the new content. The indication may, for example, be a link to enable the user to access the content via activation of the link.

In an exemplary embodiment, the second communication device 20 may represent a content source and thus, for example, the aggregator 42 may check the content source and/or various other web sites or content sources to determine whether any of the content sources or web sites include new content to be provided to the user (or for which an indication of availability is to be provided to the user). The aggregator 42 may be configured to aggregate the new content and inform the user (or multiple corresponding users) of the availability of the new content or provide the new content to applicable users.

In an exemplary embodiment, as shown in FIG. 1, the mobile terminal 10 may include a feed reader 12. The feed reader 12 may be any means such as a device or circuitry embodied in hardware, software or a combination of hardware and software that is configured to consume and/or read web feeds provided or accessible via the aggregator 42. As such, for example, the feed reader 12 may be associated with a particular application on the mobile terminal 10 that presents the feeds or content associated with feeds received at the mobile terminal 10 via the aggregator 42 to the user. Thus, for example, the feed reader 12 may be configured as an application for providing personalized home page services to the user. When informed of content such as downloaded or downloadable information that includes a media enclosure, the feed reader 12 may automatically, or in response to user instruction, attempt to download the media enclosure and present the media enclosure to the user of the mobile terminal 10.

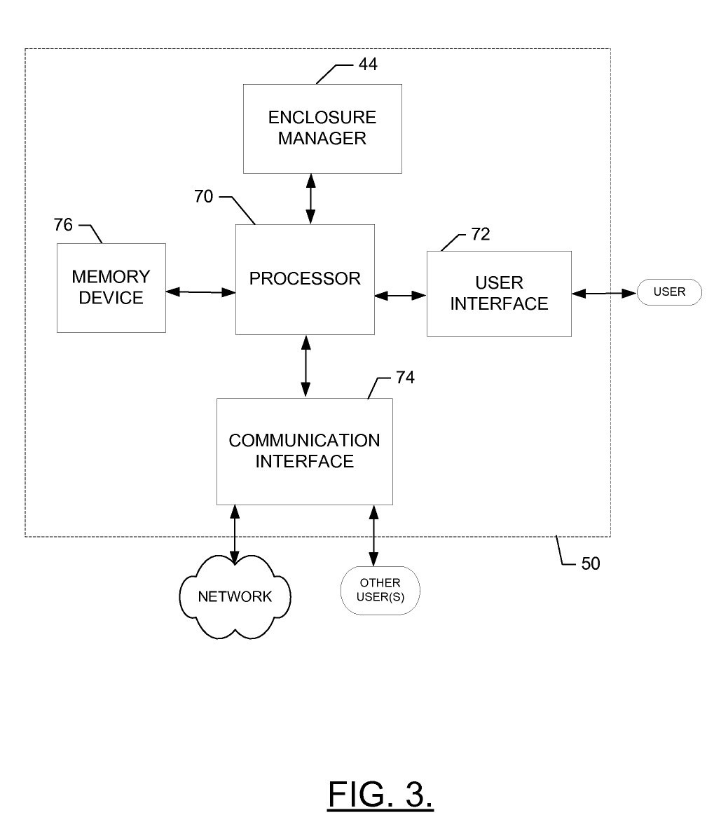

As indicated above, in some cases, some media enclosures within a feed may have formats that are not adequately described in the feed to enable the mobile terminal 10 (e.g., via the feed reader 12) to render the media enclosures. In this regard, for example, the feed reader 12 typically activates a link, such as a URL or other content address, to access content to be presented to the user. However, the URL or content address may not include information descriptive of the format of the media content. Thus, for example, if the media content that the feed reader 12 is attempting to access is not supported by the mobile terminal 10, the feed reader 12 may be unable to render the corresponding media content, and may waste resources attempting to render the media content. In this regard, since mobile devices like the mobile terminal 10 often have limited resources, they may also often have limited capabilities with respect to media content formats that are supported. According to an exemplary embodiment of the present invention, an extension to conventional feed mechanisms is provided to enable the feed reader 12 to access and render a media enclosure associated with a particular link by providing a mechanism for accessing mobile optimized alternate enclosures. In this regard, for example, the service platform 40 may further include an enclosure manager 44 configured to enable the usage of mobile optimized alternate enclosures. The enclosure manager 44 will be described in greater detail below in reference to FIG. 3.

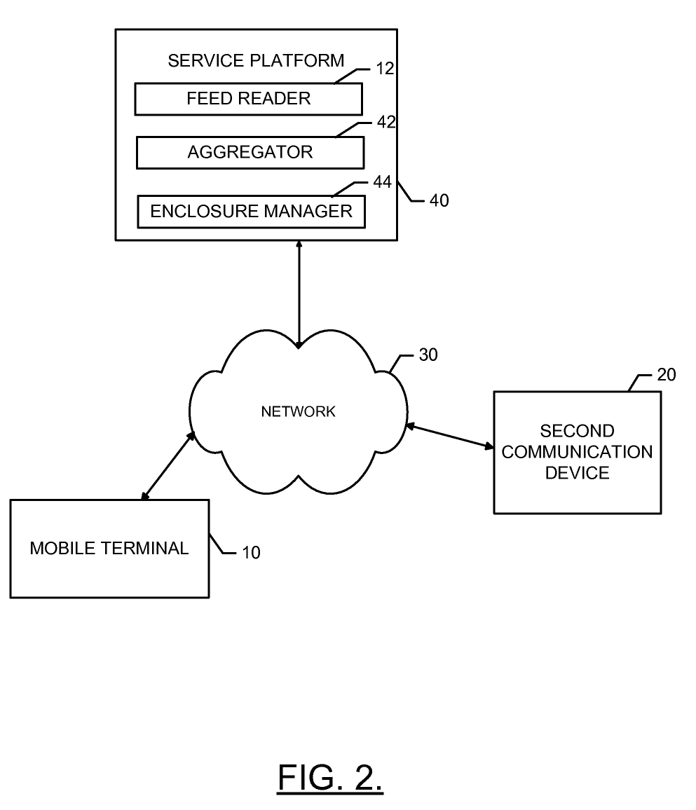

Notably, although FIG. 1 provides one example of a structure for supporting an exemplary embodiment of the present invention, alternative structures are also possible. For example, in some cases, the feed reader 12 may be an online entity. Thus, for example, the feed reader 12 may be embodied at the service platform 40 in some cases, such as the example shown in FIG. 2. In such an embodiment, a browser of the mobile terminal 10 may access the feed reader 12 online and receive content therefrom. Still other configurations are also possible in alternative embodiments and thus, the configurations shown in FIGS. 1 and 2 should not be seen as limiting to embodiments of the present invention.

FIG. 3 illustrates a schematic block diagram of an apparatus for providing compatibility of media enclosures in web feeds according to an exemplary embodiment of the present invention. An exemplary embodiment of the invention will now be described with reference to FIG. 3, in which certain elements of an apparatus 50 for providing compatibility of media enclosures in web feeds are displayed. The apparatus 50 of FIG. 3 may be employed, for example, on a communication device (e.g., the service platform 40) or a variety of other devices, both mobile and fixed (such as, for example, any of the devices listed above). Thus, for example, the apparatus 50 (which includes the enclosure manager 44) may be embodied at the service platform 40, the mobile terminal 10 or the second communication device 20 in various alternative embodiments. Alternatively, embodiments may be employed on a combination of devices. Accordingly, some embodiments of the present invention may be embodied wholly at a single device (e.g., the service platform 40, the mobile terminal 10 or the second communication device 20) or by devices in a client/server relationship. Furthermore, it should be noted that the devices or elements described below may not be mandatory and thus some may be omitted in certain embodiments.

Referring now to FIG. 3, an apparatus for providing compatibility of media enclosures in web feeds is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device comprising gates configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control the enclosure manager 44. In some embodiments, the processor may further be embodied as or otherwise control the aggregator 42 and/or the feed reader 12, such as by being configured to perform the respective functions and/or to execute the respective applications, depending on whether the apparatus 50 is embodied at a network device such as the service platform 40, a consumer device such as the mobile terminal 10 or a content authoring or originating device such as the second communication device 20. The enclosure manager 44 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the enclosure manager 44 as described herein. Thus, in examples in which software is employed, a device or circuitry (e.g., the processor 70 in one example) executing the software forms the structure associated with such means.

In an exemplary embodiment, the enclosure manager 44 may be configured to provide an extension to existing feed mechanisms in relation to handling media enclosures within feed content. In this regard, the enclosure manager 44 may be configured to enable interface with content sources (e.g., the second communication device 20) to allow content authors to define mobile optimized enclosures corresponding to original enclosures in certain situations. As an alternative, the enclosure manager 44 may be configured to provide or access by the mobile terminal 10 or feed reader 12 to one or more links to one or more corresponding alternative versions of a particular media enclosure. The alternative version or versions may be a version or versions that are supported by the mobile terminal 10 or the feed reader 12. As such, for example, the enclosure manager 42 may be configured to provide an alternative or replacement enclosure for an original media enclosure. The alternative or replacement enclosure may enable the replacement of the original media enclosure with a media enclosure that is better suited for the particular device of a mobile user. As such, the replacement enclosure may be referred to as a “mobile optimized alternative enclosure”.

When employed in connection with a feed reader, the enclosure manager 44 may enable the feed reader to check a given media stream including a media enclosure to determine whether the media enclosure is associated with an alternative enclosure. In an exemplary embodiment, the enclosure manager 44 may be configured to define an extension at a particular location. The particular location may be, for example, an XML namespace such as “urn:3gpp:metdata:feeds:2009”. The extension, which belongs to the newly defined namespace, may define one or more of the following including an address or location (e.g., a URL or Uniform Resource Identifier (URI)) of the original media enclosure link associated with feed content, media information describing a media configuration of an alternative enclosure replacing the original media enclosure, and a link reference that describes how to access the alternative enclosure. The address or identifying URI of the original media enclosure may be used to identify the enclosure that is to be replaced by the mobile optimized alternative enclosure. An example is listed below in Table 2 in which the namespace is highlighted to illustrate one example implementation.

TABLE 2
<?xml version=“1.0” encoding=“UTF-8”?>
<xs:schema xmlns:xs=“http://www.w3.org/2001/XMLSchema”

xmlns=“urn:3GPP:metadata:feeds:2009”
elementFormDefault=“qualified”
targetNamespace=“urn:3GPP:metadata:feeds:2009”>

<xs:element name=“3GPPAlternativeEnclosure”>

<xs:complexType>

<xs:sequence>

<xs:element name=“OriginalEnclosureURI” type=“xs:anyURI” minOccurs=“1”

maxOccurs=“1”/>

<xs:element name=“3GPPMediaProfile” type=“3GPPMediaProfileType”

minOccurs=“1” maxOccurs=“1”/>

<xs:element name=“Link” type=“xs:LinkType” minOccurs=“1”

maxOccurs=“1”/>

</xs:sequence>

</xs:complexType>

| </xs:element> | |
|---|---|
| <xs:complexType name=“3GPPMediaProfileType”> | <xs:sequence> |

<xs:element name=“CodecDescription” type=“CodecType” minOccurs=“0”

maxOccurs=“unbounded”/>

<xs:any namespace=“##any” processContents=“lax” minOccurs=“0”

maxOccurs=“unbounded”/>

</xs:sequence>
<xs:attribute name=“ProfileName” type=“xs:string” use=“optional”/>
<xs:anyAttribute namespace=“##any” processContents=“lax”/>

</xs:complexType>
<xs:complexType name=“CodecType”>

<xs:choice>

<xs:element name=“ContainerFormat” type=“ContainerFormatType”/>
<xs:element name=“VideoCodec” type=“VideoCodecType”/>
<xs:element name=“AudioCodec” type=“VideoCodecType”/>
<xs:element name=“MediaCodec” type=“MediaCodecType”/>

</xs:choice>

</xs:complexType>
<xs:complexType name=“ContainerFormatType”/>

<xs:attribute name=“format” type=“xs:string”/>
<xs:attribute name=“brand” type=“xs:string”/>
<xs:anyAttribute namespace=“##any” processContents=“lax”/>

</xs:complexType>
<xs:complexType name=“VideoCodecType”>

<xs:attribute name=“codec” type=“xs:string”/>
<xs:attribute name=“profile” type=“xs:string”/>
<xs:attribute name=“level” type=“xs:integer”/>
<xs:attribute name=“width” type=“xs:integer”/>
<xs:attribute name=“height” type=“xs:integer”/>
<xs:attribute name=“framerate” type=“xs:integer”/>
<xs:attribute name=“bitrate” type=“xs:integer”/>
<xs:anyAttribute namespace=“##any” processContents=“lax”/>

</xs:complexType>
<xs:complexType name=“AudioCodecType”>

<xs:attribute name=“codec” type=“xs:string”/>
<xs:attribute name=“profile” type=“xs:string”/>
<xs:attribute name=“channels” type=“xs:integer”/>
<xs:attribute name=“frequency” type=“xs:integer”/>
<xs:attribute name=“bitrate” type=“xs:integer”/>
<xs:anyAttribute namespace=“##any” processContents=“lax”/>

</xs:complexType>

<xs:complexType name=“MediaCodecType”>

<xs:attribute name=“media” type=“xs:string”/>
<xs:attribute name=“codec” type=“xs:string”/>
<xs:attribute name=“bitrate” type=“xs:integer”/>
<xs:anyAttribute namespace=“##any” processContents=“lax”/>

</xs:complexType>

</xs:schema>

As shown in table 2, supporting information about the alternative enclosure may be provided. This information may include an identifier of the 3GPPMediaProfile that specifies a set of media codecs and complexity limitations. The profiles may be registered and maintained in accordance with 3^{rd} Generation Partnership Project (3GPP). 3GPP terminals may comply to one or more of the 3GPPMediaProfiles. The information may also describe the contained media tracks (or streams). For example, a video stream may be described by indicated the video codec, the profile, the level, the video resolution, the frame rate, and the resulting bitrate. Similar information may be provided for audio streams, time text streams, rich media streams, and the like. The additional information may be helpful in the selection of the appropriate alternative enclosure as the 3GPPMediaProfile information may contain a set of optional codecs, so that terminals may or may not support all the possible codecs of that 3GPPMediaProfile.

In an exemplary embodiment, the feed reader 12 may either be a mobile optimized feed reader or a regular feed reader. In this regard, the feed reader 12 may be considered a mobile optimized feed reader if the feed reader is configured (e.g., via the enclosure manager 44) to or otherwise capable of handling the extension provided by the enclosure manager 44. Thus, for example, a regular feed reader that is not configured or otherwise enabled to handle the extension provided by the enclosure manager 44 will ignore any extensions that it does not understand and as such will not make use of the alternative enclosure. However, the mobile optimized feed reader may be able to recognize the extension and check for any alternative enclosures by referencing the namespace defined by the enclosure manager 44. If there is an alternative enclosure, the alternative enclosure may be identified, for example, through the OriginalEnclosureURI attribute. If that attribute shows the same URI as the enclosure then the alternative enclosure may be used instead. If multiple alternative enclosures are present for a single original enclosure, the feed reader 12 may be enabled to select one of the alternative enclosures (e.g., the most appropriate one) based on the device capabilities of the mobile terminal 10 and, in some cases, also based on an indicated media profile and media codecs. Since the regular feed reader is unaffected and the “mobile optimized” feed reader is enabled to handle alternative enclosures, embodiments of the present invention may be backward compatible to existing feed readers.

In an exemplary embodiment, the aggregator 42 collects a set of feeds and makes them accessible for users or feed readers. In some embodiments, the feeds may include enclosures and the feed reader 12 may be enabled to access the alternative enclosure associated with a particular original enclosure in response to the alternative enclosure being identified by the enclosure manager 44 as described above. However, in some cases, the enclosure manager 44 may be used in connection with or otherwise employed by the aggregator 42 to enable the aggregator 44 to perform additional functionality such as the addition of mobile optimized extensions to indicate alternative media enclosures. As such, for example, the aggregator 42 itself may be configured to perform media enclosure replacement in a transparent manner to the content providers and feed readers. In this regard, for example, in some embodiments, the aggregator 42 (e.g., in cooperation with the enclosure manager 44) may retrieve an original enclosure and perform operations such as transcoding to create a mobile optimized version of the enclosure.

In other words, according to one example, the aggregator 42 may be configured to check a content source for new content and, in response to identifying new content, determine whether the new content includes any media enclosures. In response to a media enclosure being included in the new content, the aggregator 42 may be configured to determine the capabilities of the mobile terminal 10 (or each respective mobile terminal) to which the new content (or an indication thereof) is to be provided. Based on the capabilities of the mobile terminal 10, the aggregator 42 may provide an alternative enclosure to replace the media enclosure in which the alternative enclosure is compatible with the media rendering capabilities of the mobile terminal. In some cases, the aggregator 42 may be configured to transcode the media enclosure to produce a version of the media enclosure that the mobile terminal 10 is capable of rendering (e.g., the alternative enclosure). Thereafter, the aggregator 42 may provide the new content (or an indication of the availability of the new content) to the mobile terminal 10 including the namespace extension described above to enable the mobile terminal to access the alternative enclosure. It should be noted that although the aggregator 42 is referred to as the actor above, the actions may be carried out by or in association with the enclosure manager 44 in some cases.

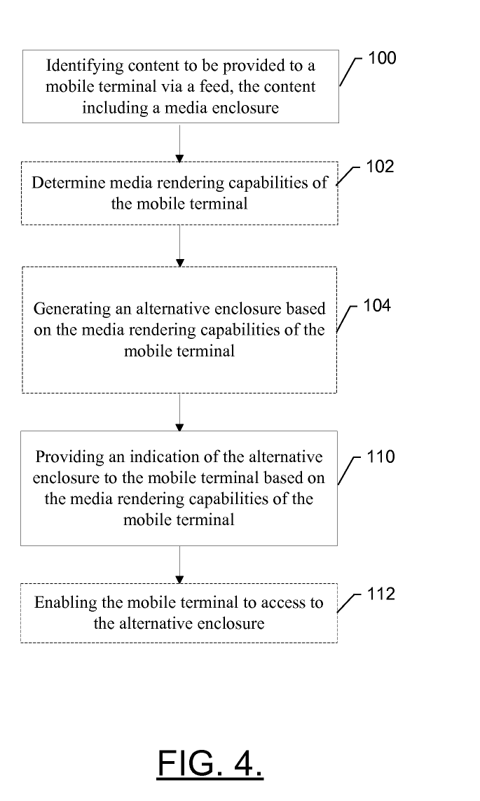

FIG. 4 is a flowchart of a system, method and program product according to some exemplary embodiments of the invention. It will be understood that each block or step of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowchart, and combinations of blocks or steps in the flowcharts, can be implemented by special purpose hardware-based computer systems which perform the specified functions or steps, or combinations of special purpose hardware and computer instructions.

In this regard, one embodiment of a method for providing compatibility of media enclosures in web feeds as illustrated, for example, in FIG. 4 may include identifying content to be provided to a mobile terminal via a feed in which the content includes a media enclosure at operation 100. The method may further include providing an indication of an alternative enclosure to the mobile terminal based on the media rendering capabilities of the mobile terminal at operation 110. The indication of the alternative enclosure may comprise a namespace defining an extension including an address of the media enclosure, media information describing the media configuration of the alternative enclosure and a link reference describing access to the alternative enclosure.

In some embodiments, the method may include further optional operations, examples of which are shown in dashed lines in FIG. 4. Any or all of the optional operations may be performed in combination with each other in various alternative embodiments. As such, the method may further include determining media rendering capabilities of the mobile terminal at operation 102. In some cases, the method may include generating the alternative enclosure based on the media rendering capabilities of the mobile terminal at operation 104. In an exemplary embodiment, the method may include enabling the mobile terminal to access the alternative enclosure at operation 112.

In some embodiments, certain ones of the operations above may be modified or further amplified as described below. It should be appreciated that each of the modifications or amplifications below may be included with the operations above either alone or in combination with any others among the features described herein. In this regard, for example, generating the alternative enclosure may include transcoding the media enclosure (e.g., in a different format) to create the alternative enclosure in a version that correlates to the media processing capabilities of the mobile terminal. In some embodiments, enabling the mobile terminal to access the alternative enclosure may include enabling the mobile terminal (or the user) to select one of a plurality of alternative enclosures based on the capabilities of the mobile terminal or based on the preferences of the user.

In an exemplary embodiment, an apparatus for performing the method of FIG. 4 above may comprise a processor (e.g., the processor 70) configured to perform some or each of the operations (100-112) described above. The processor may, for example, be configured to perform the operations (100-112) or to control the apparatus with respect to performing operations (100-112) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-112 may comprise the structure associated with, for example, the processor 70, the enclosure manager 44, and/or a device or circuit for executing instructions or executing an algorithm for processing information as described above. As such, in some embodiments, the apparatus for performing the method of FIG. 4 may include at least one processor and at least one memory storing computer program code. The at least one memory and the computer program code may be configured to, with the processor, perform the operations (100-112).

Thus, a method according to an exemplary embodiment of the present invention may include identifying content to be provided to a mobile terminal via a feed in which the content includes a media enclosure, and providing an indication of an alternative enclosure to the mobile terminal based on the media rendering capabilities of the mobile terminal. An apparatus according to an exemplary embodiment may include at least one processor and at least one memory storing computer program code. The at least one memory and the computer program code may be configured to, with the processor, perform at least identifying content to be provided to a mobile terminal via a feed in which the content includes a media enclosure, and providing an indication of an alternative enclosure to the mobile terminal based on the media rendering capabilities of the mobile terminal. An exemplary computer program product may include at least one computer-readable storage medium having computer-executable program code instructions stored therein. The computer-executable program code instructions may include program code instructions for identifying content to be provided to a mobile terminal via a feed in which the content includes a media enclosure, and providing an indication of an alternative enclosure to the mobile terminal based on the media rendering capabilities of the mobile terminal.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
identifying content to be provided to a mobile terminal via a feed, the content including a media enclosure; and
providing an indication of an alternative enclosure to the mobile terminal based on media rendering capabilities of the mobile terminal, the indication of the alternative enclosure comprising a namespace defining an extension including an address of the media enclosure, media information describing a media configuration of the alternative enclosure and a link reference describing access to the alternative enclosure.

2. The method of claim 1, further comprising determining the media rendering capabilities of the mobile terminal.

3. The method of claim 2, further comprising generating an alternative enclosure based on the determined media rendering capabilities of the mobile terminal.

4. The method of claim 3, wherein generating the alternative enclosure comprises transcoding the media enclosure in a different format to create the alternative enclosure in a version that correlates to the media processing capabilities of the mobile terminal.

5. The method of claim 1, further comprising enabling the mobile terminal to access the alternative enclosure.

6. The method of claim 5, wherein enabling the mobile terminal to access the alternative enclosure may include enabling the mobile terminal to provide a selection of one of a plurality of alternative enclosures based on the capabilities of the mobile terminal.

7. The method of claim 5, wherein enabling the mobile terminal to access the alternative enclosure may include enabling the mobile terminal to provide a selection of one of a plurality of alternative enclosures based on preferences of a user of the mobile terminal.

8. An apparatus comprising at least one processor and at least one memory including computer program code, the at least one memory and the computer program code configured to, with the at least one processor, cause the apparatus at least to:
identify content to be provided to a mobile terminal via a feed, the content including a media enclosure; and
provide an indication of an alternative enclosure to the mobile terminal based on media rendering capabilities of the mobile terminal, the indication of the alternative enclosure comprising a namespace defining an extension including an address of the media enclosure, media information describing a media configuration of the alternative enclosure and a link reference describing access to the alternative enclosure.

9. The apparatus of claim 8, wherein the at least one memory and the computer program code are further configured to, with the at least one processor, cause the apparatus to determine media rendering capabilities of the mobile terminal.

10. The apparatus of claim 9, wherein the at least one memory and the computer program code are further configured to, with the at least one processor, cause the apparatus to generate an alternative enclosure based on the determined media rendering capabilities of the mobile terminal.

11. The apparatus of claim 10, wherein the at least one memory and the computer program code are further configured to, with the at least one processor, cause the apparatus to generate the alternative enclosure by transcoding the media enclosure in a different format to create the alternative enclosure in a version that correlates to the media processing capabilities of the mobile terminal.

12. The apparatus of claim 8, wherein the at least one memory and the computer program code are further configured to, with the at least one processor, cause the apparatus to enable the mobile terminal to access the alternative enclosure.

13. The apparatus of claim 8, wherein the at least one memory and the computer program code are further configured to, with the at least one processor, cause the apparatus to enable the mobile terminal to access the alternative enclosure by enabling the mobile terminal to provide a selection of one of a plurality of alternative enclosures based on the capabilities of the mobile terminal.

14. The apparatus of claim 8, wherein the at least one memory and the computer program code are further configured to, with the at least one processor, cause the apparatus to enable the mobile terminal to access the alternative enclosure by enabling the mobile terminal to provide a selection of one of a plurality of alternative enclosures based on preferences of a user of the mobile terminal.

15. A computer program product comprising at least one computer-readable storage medium having computer-executable program code portions stored therein, the computer-executable program code portions comprising program code instructions for:
identifying content to be provided to a mobile terminal via a feed, the content including a media enclosure; and
providing an indication of an alternative enclosure to the mobile terminal based on media rendering capabilities of the mobile terminal, the indication of the alternative enclosure comprising a namespace defining an extension including an address of the media enclosure, media information describing a media configuration of the alternative enclosure and a link reference describing access to the alternative enclosure.

16. The computer program product of claim 15, further comprising program code instructions for determining media rendering capabilities of the mobile terminal.

17. The computer program product of claim 16, further comprising program code instructions for generating an alternative enclosure based on the determined media rendering capabilities of the mobile terminal.

18. The computer program product of claim 17, wherein code instructions for generating the alternative enclosure include instructions for transcoding the media enclosure in a different format to create the alternative enclosure in a version that correlates to the media processing capabilities of the mobile terminal.

19. The computer program product of claim 15, further comprising program code instructions for enabling the mobile terminal to access the alternative enclosure.

20. The computer program product of claim 19, wherein program code instructions for enabling the mobile terminal to access the alternative enclosure include instructions for enabling the mobile terminal to provide a selection of one of a plurality of alternative enclosures based on the capabilities of the mobile terminal.
